(19) United States
(12) Patent Application Publication
(10) Pub. No.: US 2009/0095428 A1
(43) Pub. Date: Apr. 16, 2009

(54) HAND-HELD DEVICE FOR UNWINDING AN ADHESIVE TAPE HAVING A DOUBLE-SIDEDLY ADHESIVELY FURNISHED CARRIER, AT LEAST ONE OF THE TWO ADHESIVE SIDES OF THE CARRIER BEING LINED WITH A RELEASE MATERIAL

(75) Inventors: Michael Schwertfeger, Hamburg (DE); Kerstin Gotz, Hamburg (DE); Christoph Nagel, Hamburg (DE)

Correspondence Address: NORRIS, MCLAUGHLIN & MARCUS, 875 THIRD AVE, 18TH FLOOR, NEW YORK, NY, 10022, US

(73) Assignee: TESA AKTIENGESELLSCHAFT, HAMBURG (DE)

(21) Appl. No.: 12/247,695

(22) Filed: Oct. 8, 2008

(30) Foreign Application Priority Data
Oct. 10, 2007 (DE) 10 2007 048 803.5
Jan. 7, 2008 (DE) 10 2008 003 337.5

(51) Int. Cl. B32B 38/10; B32B 38/18

(52) U.S. Cl. 156/510; 156/538

(57) ABSTRACT

The invention relates to a hand-held device 100 for unwinding an adhesive tape 41 which is located in the form of an Archimedean spiral on a roll 4 and has a double-sidedly adhesively furnished carrier, at least one of the two adhesive sides of the carrier being lined with a release material 42, consisting of a handle 1 which is disposed on a retaining plate 2, a holder 21, mounted rotatably on the retaining plate 2, for the roll 4 of the adhesive tape 41, a take-off apparatus 22, connected to the retaining plate 2, and more particularly in the form of a roller, via which the adhesive tape 41 is guided such that the release material 42 is in direct contact with the take-off apparatus 22, and the adhesive tape 41 is taken off from the roll 4 during the dispensing operation, a take-off apparatus 23, connected to the retaining plate 2, and more particularly in the form of a roller, via which the adhesive tape 41 is guided such that the release material 42 is in direct contact with the take-off apparatus 23, and the release material 42 is taken off from the adhesive tape 42 during the dispensing operation, a contact roll 24, mounted rotatably on the retaining plate 2, which during the dispensing operation brings the adhesive tape 41 into contact with the substrate, and a release material accommodation roll 25, mounted rotatably on the retaining plate 2, which accommodates the release material 42 after it has been taken off from the adhesive tape 41, and which is non-positively connected to the holder 21, so that movement of the holder 21 sets the release material accommodation roll 25 in rotation.

### BACKGROUND OF THE INVENTION

(1) Field of the Invention

The invention relates to a hand-held device by means of which adhesive tape which is located in the form of an Archimedean spiral on a roll and has a double-sidedly adhesively furnished carrier, at least one of the two adhesive sides of the carrier being lined with a release material, can be unwound, more particularly adhesive tapes which enable the splicing that is needed in the paper and printing industries for joining two reels of paper.

(2) Description of Related Art

In plants which operate with flat-web material wound up onto reels, reel change is frequently carried out using pressure-sensitive adhesive tapes. A distinction is made between static and dynamic reel changes. In the case of static reel change, the machine is halted and the end of the old web is bonded to the start of the new web. A feature of dynamic reel change, also known as flying reel change, is that there is no need to halt the high-speed machine for the reel change.

In the film-processing industry or the like, flying reel changes are carried out in two fundamentally distinctive processes.

In one process, double-sidedly self-adhesive tapes are bonded manually to the start of the new web in the form of a W or V or any other advantageous arrangement. The web material protruding beyond the edge of the adhesive tape is subsequently cut off. The start of the new web is subsequently attached, using so-called fixing labels, to the underlying turn of the reel, in order to prevent the web unwinding when the new reel is accelerated to the circumferential speed of the old roll. This operation is very time-consuming, requires deployment of skilled personnel, and leads to technically non-advantageous results, since, as a result of the sequence of web material, fixing labels and adhesive strips, the bonds are relatively thick. Where, moreover, the web materials are thin and flexible, there is a risk of the stream of air in the opposite direction that occurs in the course of rotation causing bulges to appear in the web material between the fixing labels at the start of the new web. These bulges generally lead to poor splicing efficiency.

In the second known process, a single-sidedly self-adhesive tape is bonded overlapping and in a straight line beneath the topmost web of the new roll, so that the adhesive side points outwards and is only partly covered by the new web. In order to prevent the web unwinding when the new reel is accelerated to the circumferential speed of the old reel, a liquid is applied between the topmost turn and the underlying turn. This operation likewise requires the deployment of skilled personnel and leads to technically non-advantageous results, since the fixing of the web material with a liquid is dependent on a very large number of parameters—for example, on the surface energy of the film material, the flexibility, the basis weight, the polarity and viscosity of the liquid used, the liquid volume, and the thickness and surface area of the liquid film, to name but a few.

Bonding in preparation for splicing is nowadays carried out manually. Owing to the size of the paper bales (which are up to ten metres wide) on which the bonding is carried out, handling in the course of bonding is made very much more difficult by the release paper which has to be removed beforehand.

This is the reason that has given rise to the desire for a simple but effective application device.

Unwinders present on the market are unsuitable, for a variety of reasons.

Simple hand-held devices for single-sidedly adhesive products are unsuitable since the release paper cannot be taken off by these devices.

The known hand-held devices for double-sidedly adhesive products are also not suitable, since in this case, either the release paper is always taken off only after the adhesive side has been applied, or, in the case of hand-held applicators with a blade, the sensitive carrier material of adhesive splicing tapes for the printing industry is damaged by the slitting operation; in any case, however, the unwinding of the adhesive tape does not take place at an angle of 180° via a take-off apparatus, and this may likewise cause premature damage to the adhesive splicing tape for the printing industry. With all commercial dispensers, moreover, the rotational movement of the contact roll is used as the drive for the winding of the release paper within the device.

The majority of hand-held devices, moreover, are considered to be much too large and heavy for use, in other words they are seen as being inconvenient. The reason for this is the very long bonding path over which the tape must be bonded and which must absolutely be straight and creaseless. Users are used to bonding only short paths, section by section, so as to be able to correct the direction continually. The hand-held dispenser must not make this more difficult.

A further great problem, particularly in the context of the dispensing of adhesive splicing tapes, is represented by the low splitting forces of the adhesive tapes.

These splittable systems have a very frequent tendency to undergo incipient splitting during unwinding and application—that is, the splittable carrier begins to split—and this adversely affects the subsequent splice formed with the adhesive tape or, in the extreme case, i.e. when the carrier splits completely, it entails extra effort as a result of reapplication of the adhesive tape.

DE 10 2005 034 007 A1 discloses a hand-held device for unwinding an adhesive tape from a carrier, more particularly a single-sidedly adhesively furnished carrier, whose adhesive is lined with a release material, the adhesive tape being wound into a roll in the form of an Archimedean spiral, generally around a cardboard core.

The hand-held device consists of a frame at one end of which there is a holder for the roll of adhesive tape, so that the roll of adhesive tape is mounted rotatably, and at whose other end there are at least three rollers via which the adhesive tape for unwinding is guided, the central axes of the rollers being aligned parallel to one another and substantially parallel to the central axis of the roll holder.

The holder is usually composed of one or two cylindrical or journal-like extensions whose outer diameter corresponds approximately to the inner diameter of the core of the adhesive roll to be held. The adhesive tape roll is pushed onto the extensions. The adhesive tape roll must not sit too firmly, hindering its rotation, but must also not sit too lightly, which would make it more difficult to carry out precise guiding of the adhesive tape to be unwound.

For dispensing, the adhesive tape is unwound from the roll and guided through a first roller nip between the first and second rollers. After the first roller nip, the tape is separated into the carrier, more particularly single-sidedly adhesively furnished carrier, and the release material.

The carrier wraps at least partly around the first roller and is supplied to the substrate at which the carrier is to be dispensed.

At the same time, the release material is wrapped around the second roller and is guided into a second roller nip between the second and third rollers.

The release material, furthermore, wraps at least partly around the third roller and is taken off. The second or third roller, or both, may rotate in order to guide the carrier and/or release material.

Mention is made only by way of example, furthermore, of an unwinder of the type disclosed in DE 102 54 288 A1. The apparatus therein for unwinding a web of carrier material located on a roll and bearing in particular double-sidedly adhesively furnished tape sections is composed of
a handle which is disposed on a retaining plate,
mounted rotatably on the retaining plate, a holder for the roll of carrier material web,
mounted rotatably on the retaining plate, a contact roll which brings the carrier material web with the adhesive tape sections into contact with the substrate during the dispensing operation and via which the carrier material web with the adhesive tape sections is guided by the holder for the roll such that, in the course of the dispensing operation, the adhesive tape sections are dispensed from the carrier material web onto the substrate,
mounted rotatably on the retaining plate, a drive roll via which the carrier material web with the adhesive tape sections is guided such that the drive roll rotates synchronously with the speed of the carrier material web,
mounted rotatably on the retaining plate, an accomodation roll which accommodates the carrier material web after the adhesive tape sections have been dispensed, and which more particularly is set in rotation via a belt by the movement of the drive roll.

### BRIEF SUMMARY OF THE INVENTION

It is an object of the invention to provide a hand-held device which, while having a very simple construction, is small, lightweight and suitable for dispensing an adhesive tape which is present in a roll in the form of an Archimedean spiral, the adhesive tape having a double-sidedly adhesively furnished carrier, and with at least one of the two adhesive sides of the carrier being lined with a release material, and to do so more particularly for adhesive tapes which allow the splice needed in the paper and printing industries for joining two reels of paper.

This object is achieved by means of a hand-held device as set out in claim 1. Developments of the hand-held device of the invention are subject matter of the dependent claims.

The invention accordingly provides a hand-held device for unwinding an adhesive tape which is located in the form of an Archimedean spiral on a roll and has a double-sidedly adhesively furnished carrier, at least one of the two adhesive sides of the carrier being lined with a release material, consisting of
a handle which is disposed on a retaining plate,
a holder, mounted rotatably on the retaining plate, for the roll of the adhesive tape, on which the roll is preferably non-positively seated,
a take-off apparatus, connected to the retaining plate, and more particularly in the form of a roller, via which the adhesive tape is guided such that the release material is in direct contact with the take-off apparatus, and the adhesive tape is taken off from the roll during the dispensing operation,
a take-off apparatus, connected to the retaining plate, and more particularly in the form of a roller, via which the adhesive tape is guided such that the release material is in direct contact with the take-off apparatus, and the release material is taken off from the adhesive tape during the dispensing operation,
a contact roll, mounted rotatably on the retaining plate, which during the dispensing operation brings the adhesive tape into contact with the substrate, and
a release material accommodation roll, mounted rotatably on the retaining plate, which accommodates the release material after it has been taken off from the adhesive tape, and which is non-positively connected to the holder, so that movement of the holder sets the release material accommodation roll in rotation.

According to one first advantageous embodiment of the invention, the non-positive connection between release material accommodation roll and holder is made via a belt which is guided via the axes of release material accommodation roll and holder.

With further preference the belt takes the form of a rubber O-ring.

The non-positive connection allows a slip, so that the circumferential speed of the outer ply of the coil of release material that forms is always made virtually identical to the circumferential speed of the outer ply of the unwinding adhesive tape.

This ensures trouble-free unwinding and dispensing of the adhesive tape, and simultaneous winding of the release material.

According to one further advantageous embodiment of the hand-held device, there is an adjustable brake, more particularly a friction brake, present in the holder for the roll of the adhesive tape.

This friction brake, however, is not needed in particular in the embodiment of the hand-held device in which a belt is provided, since the braking of the roll when the dispensing operation is terminated is accomplished by that said belt.

According to one further preferred embodiment of the invention, the take-off apparatus is connected pivotably to the retaining plate more particularly via a frame.

One end of the frame is mounted in the retaining plate; the other end is formed by the axis of the take-off apparatus. The long sides of the frame form the radius of a circle whose central point represents the fixing of the frame on the retaining plate. Accordingly the take-off apparatus can be pivoted in rotation about the fixing point.

According to a further advantageous embodiment of the hand-held device, the take-off of the adhesive tape from the roll takes place via the take-off apparatus such that the take-off angle is at least 180°.

In this way, the take-off apparatus is always pressed onto the roll with the adhesive tape; more particularly, the pressing increases in strength at the moment the adhesive tape is taken off from the roll.

The advantageous constructional implementation of the mounting of the take-off apparatus ensures that the take-off apparatus, preferably roll, always bears against the surface of the outer ply of the adhesive tape and hence automatically always ensures the take-off angle of 180°. The preferred take-off roller is adapted—in terms of its diameter, its position and the force with which it bears on the final ply of the adhesive tape—to the respective adhesive tape in such a way that the unwinding forces which still act proportionally on the adhesive tape, which, as stated, preferably has a splittable carrier, are always smaller than the splitting forces of the splittable system. As a result, the sensitive product can be unwound without disruption.

According to one further advantageous embodiment of the hand-held device, between take-off apparatus and the contact roll there is a parting unit which is able to sever the adhesive tape.

According to a further advantageous embodiment of the hand-held device, the parting unit is composed of two blades which can be brought together in scissor-like fashion for the parting operation.

Furthermore, it ought to be possible to initiate the parting operation in the parting unit at the handle via an apparatus. This apparatus is composed, for example, of a Bowden cable, which can be controlled via a lever, the latter being located on the handle.

Preferably the blade can be moved in and out. Preferably the blade, in the moved-in state, is completely surrounded by a corresponding capsule, in order to rule out injury to the user in the course of handling.

In the moved-out state, the blade is exposed, and by virtue of its particular geometry, in the form for example of the point of an arrow, it generates an initially pointwise high cutting force and hence cuts very cleanly and precisely even under low cutting pressure. This is necessary because the adhesive tapes with a splittable carrier, if the cutting force is too low, tend to tear apart and hence also again to begin splitting.

According to one further advantageous embodiment of the hand-held device, the take-off of the release material from the adhesive tape takes place via the take-off apparatus, so that the take-off angle is at least 90°.

This construction ensures that the release material is removed reliably.

According to one further advantageous embodiment of the hand-held device, on at least one of the two end faces of the release material accommodation roll there is a disc provided whose diameter is greater than the diameter of the release material accommodation roll.

This disc or these discs prevent telescoping of the coil of release material that forms.

According to one further advantageous embodiment of the hand-held device, the handle and also all other components can be installed in mirror-image form on the retaining plate.

The contact roll more particularly, but also all other rolls which come into contact with an exposed adhesive, are preferably given an anti-adhesive finish, in order to prevent blocking or sticking.

According to one further advantageous embodiment of the hand-held device, the release paper has a slit extending in longitudinal direction.

A slitted release paper is used more particularly in the case of adhesive tapes which find use for static or dynamic reel change in the (paper) industry. In the case of this preferred version, then only half of the release paper or, more generally, of the release material is taken from the adhesive tape and wound up, while the other half remains on the adhesive tape.

The concept of the invention embraces, finally, the hand-held device in conjunction with an adhesive tape which is located in the form of an Archimedean spiral on a roll and is composed of a double-sidedly adhesively furnished carrier, at least one of the two adhesive sides of the carrier being lined with a release material.

Suitable materials for the components of the hand-held device include plastics, although a metal version is also possible. The rollers described are preferably coated or surface-machined such that the transport of the covered adhesive tape, or else of the at least partly uncovered adhesive tape, is facilitated by effective static friction. One exemplary version uses rubber-coated metal rollers, although knurled metal rollers are also suitable, for example.

The hand-held device permits uniform take-off of a double-sided adhesive tape lined with a release material even from a roll that may have undergone telescoping. It is very simple in construction, small and lightweight.

The device makes it possible more particularly to dispense splittable adhesive tapes onto reels of paper, for example, for the purpose of preparing for splicing of the paper. Premature splitting of the adhesive tape before or during the dispensing operation is not observed.

Carriers used for the adhesive tape are preferably splittable carriers. Adhesive tapes of this kind are used in preparation for the splicing of reels of paper in particular. In the course of splicing, i.e. the joining of two reels of paper in ongoing operation, the carrier splits irreversibly.

In a further preferred embodiment the splittable carrier used in the adhesive tape to be dispensed comprises a splittable system based preferably on sized and highly compacted paper, on a composite of paper and film or on a composite of two films, it being possible for the composite to be composed of films and/or papers joined linearly and/or pointwise in a defined fashion. Examples of papers, paper composite systems or films suitable for this purpose include more particularly the following:
Duplex papers:
Duplex papers are papers which are laminated together, for which the splitting operation is extremely homogeneous, with no stress peaks as a result, for example, of inhomogeneous compaction. These papers are available commercially and are employed for example in the production of filter materials and wall coverings.
Readily splitting papers:
These are highly compacted papers (i.e. papers with a high splitting resistance) that are sized together. Sizing can be done using, for example, starch, derivatives containing starch, methylcellulose-based wallpaper pastes (Tesa® Kleister, tesa AG, Hamburg; Methylan®, Henkel KgaA, Düsseldorf) or else wallpaper pastes based on polyvinyl alcohol derivatives. Systems of this kind are described in EP 0 757 657 A1, for example. The splitting energy is adjusted via the compaction of the paper fibre structure. The lower the degree of compaction, the lower the splittability.
Additionally suitable paper systems are, for example, machine-finished papers calendered on one side, or else highly filled kraft papers.
Sized paper systems:
The splittability is adjusted via the chemistry of the size. The size ought not to have substantially penetrated the paper.
Additionally a splitting system comprising a material which separates between top and bottom face under normal force (in accordance with DE 198 41 609 A1) can be used.
Coextruded films

Relevant adhesive tapes which are outstandingly suitable in conjunction with the hand-held device of the invention are known from the paper industry for bonding in the context of flying reel change. Processes for preparing for and for implementing the reel change, and corresponding adhesive tapes, are presented in, for example, the publications EP 0 418 527 A2, DE 40 33 900 A1, DE 196 28 317 A1 and DE 198 30 673 A1. The nonadhesive covering of otherwise open adhesive areas is disclosed by DE 196 32 689 A2, an adhesive tape for dynamic loads during the splicing process, whose paper carrier splits and, with its remnants, covers the adhesive. Also of this kind is an adhesive tape according to DE 199 02 179 A1, likewise for a splicing process. The adhesive tape carries on its non-adhesive reverse face a double-sided adhesive tape which has a readily splitting paper carrier which, during the splicing process, splits and covers the respective adhesive. In order to avoid instances of tearing, the adhesive tape laminated on, with a paper carrier made of splittable paper, is arranged in a recessed format, namely at a certain distance from the long edge of the adhesive tape. A further version is an adhesive tape with two splitting strips, described in DE 198 30 674 A1.

This enumeration, however, should not be interpreted as being conclusive; instead, there are a multiplicity of further documents which describe adhesive tapes for splicing (paper) and hence tapes suitable in accordance with the invention.

Another splittable adhesive tape having a left (l) and a right (r) bordering edge is known from DE 10 2005 051 181 A1. At least one of these two edges (l, r) is non-linear, the non-linear edge (l) having projections (V). The adhesive tape disclosed in that publication, in particular, interacts outstandingly with the hand-held device of the invention.

The purpose of the text below is to illustrate in more detail, using the figure, the hand-held device of the invention in one advantageous embodiment, without thereby wishing to subject the invention to any unnecessary restriction.

### BRIEF DESCRIPTION OF THE SEVERAL VIEWS OF THE DRAWING(S)

FIG. 1 shows the hand-held device of the invention in a side view.

### DETAILED DESCRIPTION OF THE INVENTION

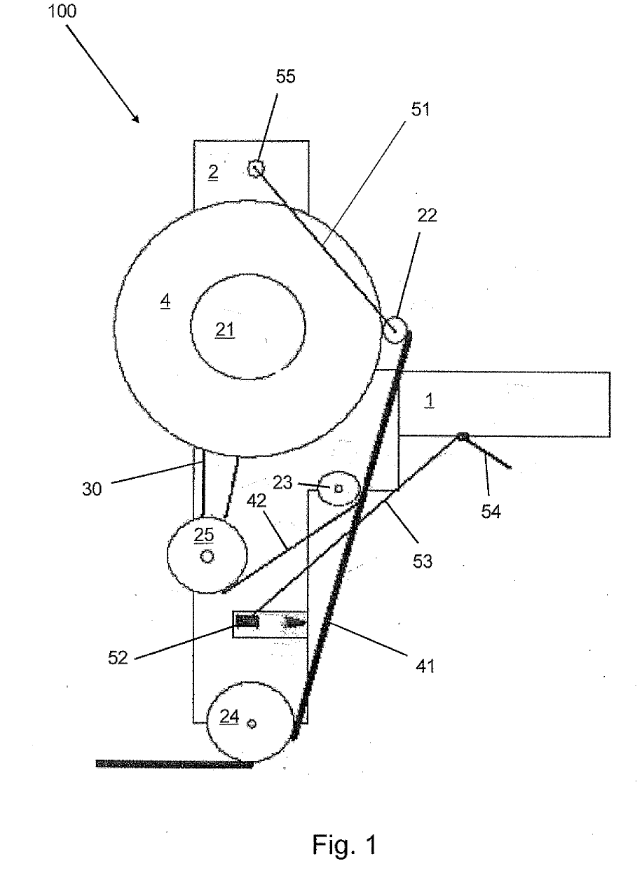

As shown in side view in FIG. 1, the hand-held device 100 is used to unwind an adhesive tape 41, which is located in the form of an Archimedean spiral on a roll 4, and which has a double-sidedly adhesively furnished carrier, at least one of the two adhesive sides of the carrier being lined with a release material 42.

The hand-held device 100 has essentially the following components:
a handle 1, which is mounted on a retaining plate 2,
a holder 21, mounted rotatably on the retaining plate 2, for the roll 4 of the adhesive tape 41, on which the roll 4 is non-positively seated,
a take-off roller 22 connected to the retaining plate 2, via which the adhesive tape 41 is guided such that the release material 42 is in direct contact with the take-off roller 22, and the adhesive tape 41 is taken off from the roll 4 during the dispensing operation,
a take-off roller 23, connected to the retaining plate 2, via which the adhesive tape 41 is guided such that the release material 42 is in direct contact with the take-off roller 23, and the release material 42 is taken off from the adhesive tape 41 during the dispensing operation,
a contact roll 24, mounted rotatably on the retaining plate 2, which during the dispensing operation brings the adhesive tape 41 into contact with the substrate, and
a release material accommodation roll 25, mounted rotatably on the retaining plate 2, which accommodates the release material 42 after it has been taken off from the adhesive tape 41, and which is non-positively connected to the holder 21, so that movement of the holder 21 sets the release material accommodation roll 25 in rotation.

The non-positive connection between release material accommodation roll 25 and holder 21 is made via a belt 30 in the form of a rubber O-ring, which is guided via the axes of release material accommodation roll 25 and holder 21.

With further preference the belt 30 takes the form of a rubber O-ring.

The take-off roller 22 is connected pivotably to the retaining plate 2 via a frame 51.

One end of the frame 51 is mounted rotatably in the retaining plate 2; the other end is formed by the axis of the take-off roller 22. The long sides of the frame 51 form the radius of a circle whose central point is represented by the fixation 55 of the frame 51 on the retaining plate 2. Accordingly the take-off roller 22 can be pivoted in rotation about the fixing point.

The take-off of the adhesive tape 41 from the roll is accomplished via the take-off apparatus 22 in such a way that the take-off angle is 185°.

Between take-off roller 23 and the contact roll 24 there is a parting unit 52 in the form of two blades, which for the parting operation are brought together in a scissor-like fashion. The blade and hence the parting operation are initiated on the handle 1 via a lever 54 which is installed on the handle 1 and which actuates a Bowden cable 53.

The release material 42 is taken off from the adhesive tape 41 via the take-off roller 23, here with a take-off angle of 45°, which preferably, however, is at least 90°.

1. A hand-held device for unwinding an adhesive tape formed in shape of an Archimedean spiral on a roll and having a double-sidedly adhesive carrier, at least one of two adhesive sides of the carrier being lined with a release material,
the device comprises
a handle 1,
a retaining plate 2, the handle being disposed on the retaining plate,
a holder 21, mounted rotatably on the retaining plate 2, acconmmodating the roll 4 of the adhesive tape 41,
a take-off apparatus 22, connected to the retaining plate 2, and in form of the roller, via which the adhesive tape 41 is guided such that the release material 42 is in direct contact with the take-off apparatus 22, and the adhesive tape 41 is taken off from the roll 4 during the dispensing operation,
a take-off apparatus 23, connected to the retaining plate 2, and in the form of a roller, via which the adhesive tape 41 is guided such that the release material 42 is in direct contact with the take-off apparatus 23, and the release material 42 is taken off from the adhesive tape 41 during the dispensing operation,
a contact roll 24, mounted rotatably on the retaining plate 2, which during the dispensing operation brings the adhesive tape 41 into contact with a substrate, and a release material accommodation roll 25, mounted rotatably on the retaining plate 2, which accommodates the release material 42 after it has been taken off from the adhesive tape 41, and which is non-positively connected to the holder 21, so that movement of the holder 21 sets the release material accommodation roll 25 in rotation.

2. The hand-held device according to claim 1, wherein
the non-positive connection between the release material accommodation roll 25 and the holder 21 is made via a belt 30 which is guided via an axes of release material accommodation roll 25 and the holder 21.

3. The hand-held device according to claim 2, wherein the belt 30 is a rubber O-ring.

4. The hand-held device according to claim 1, wherein an adjustable brake is present in the holder 21 for the roll 4 of the adhesive tape 41.

5. The hand-held device according to claim 1, wherein the take-off apparatus 22 is connected pivotably to the retaining plate 2.

6. The hand-held device according to claim 1, wherein the take-off of the adhesive tape 41 from the roll takes place via the take-off apparatus 22 such that the take-off angle is at least 180°.

7. The hand-held device according to claim 1, wherein between take-off apparatus 23 and the contact roll 24 there is a parting unit 52 which is capable of severing the adhesive tape.

8. The hand-held device according to claim 7, wherein the parting unit 52 comprises two blades which are capable of being brought together in scissor-like fashion for the parting operation.

9. The hand-held device according to claim 8, wherein the parting operation in the parting unit 52 is initiated at the handle 1 via an apparatus 53.

10. The hand-held device according to claim 1, wherein the take-off of the release material 42 from the adhesive tape 41 takes place via the take-off apparatus 23 such that the take-off angle is at least 90°.

11. The hand-held device according to claim 1, wherein the release material has two end faces and wherein on at least one of the two end faces of the release material accommodation roll 25 there is a disc provided having a diameter greater than the diameter of the release material accommodation roll 25.

12. The hand-held device according to claim 1, wherein the handle 1 is accommodated in mirror-image form on the retaining plate 2.

13. The hand-held device according to claim 1, wherein the release material 42 has a slit extending in longitudinal direction.

14. The hand-held device according to claim 1, wherein the adhesive tape 41 which is located in the form of an Archimedean spiral on a roll 4, is composed of a double-sidedly adhesive carrier and at least one of the two adhesive sides of the carrier being lined with a release material 42.

15. The hand-held device according to claim 4, wherein the adjustable brake is a friction brake.

16. The hand-held device according to claim 5, wherein the take-off apparatus 22 is connected pivotably to the retaining plate 2 more particularly via a frame 51.
